(19) United States
(12) Patent Application Publication
(10) Pub. No.: US 2013/0027501 A1
(43) Pub. Date: Jan. 31, 2013

(54) IMAGE FORMING APPARATUS THAT USES LASER BEAM

(71) Applicant: Yuzuru Yano, Moriya-shi (JP)

(72) Inventor: Yuzuru Yano, Moriya-shi (JP)

(73) Assignee: CANON KABUSHIKI KAISHA, Tokyo (JP)

(21) Appl. No.: 13/554,362

(22) Filed: Jul. 20, 2012

(30) Foreign Application Priority Data
Jul. 25, 2011 (JP) 2011-162048

(51) Int. Cl. B41J 2/435

(52) U.S. Cl. 347/247

(57) ABSTRACT

An image forming apparatus which is capable of properly correcting a scanning length while suppressing occurrence of moiré fringes to reduce degradation of image quality. A laser drive device generates laser beam by driving a laser beam source on an auxiliary pixel basis according to a lighting pattern that defines a pattern for turning on or off the laser beam on an auxiliary pixel basis. A CPU sets the scanning magnification of a photosensitive member in a main scanning direction. Further, the CPU sets the lighting pattern, based on the image data, according to the set scanning magnification, pixel by pixel basis such that the lighting pattern becomes aperiodic in a sequence of pixels. The CPU outputs the lighting pattern to the laser drive device.

### BACKGROUND OF THE INVENTION

1. Field of the Invention

The present invention relates to an image forming apparatus for forming a latent image on a photosensitive member by laser beam.

2. Description of the Related Art

Conventionally, there has been known an image forming apparatus that converts input multi-value image data into binary PWM (pulse width modulation) data, and generates a laser drive signal (PWM signal) based on the PWM data, for driving a laser beam source, as disclosed in Japanese Patent Laid-Open Publication No. 2005-96351.

A minimum unit for forming PWM data is defined as an auxiliary pixel. One pixel is formed by a plurality of auxiliary pixels. The above-mentioned conventional image forming apparatus adds or deletes associated auxiliary pixel data to or from PWM data generated from the input multi-value image data, in order to correct non-uniformity of a scanning length caused by an inclination of an image bearing member (photosensitive member) from a correct axial position thereof, skewness of an optical system, or the like, and generates the PWM signal based on the PWM data to which or from which the auxiliary pixel data is added or deleted. Further, the image forming apparatus is equipped with a counter circuit for determining a position in the PWM data generated from the input multi-value image data, where addition or deletion of the auxiliary pixel data is to be executed.

The counter circuit performs a counting operation during formation of an image, and generates a timing signal for adding or deleting the auxiliary pixel data to or from the PWM data generated from the input multi-value image data in timing in which a counter value has reached a predetermined threshold value. The threshold value is set according to a degree of magnification of an image in the main scanning direction of the image forming apparatus. As the threshold value is lower, the frequency of addition or deletion of an auxiliary pixel increases.

However, the above-described conventional image forming apparatus suffers from a problem that interference fringes (moiré fringes) are generated between lines of image generated by addition or deletion of auxiliary pixels and image portions having a periodicity since the timing for adding or deleting auxiliary pixel data is fixed.

Next, a description will be given of an example of generation of moiré fringes, with reference to FIGS. 12 to 14. For simplicity of explanation, the description is given by taking as an example a case where an image is formed by pixels each formed of sixteen auxiliary pixels.

FIG. 12 shows PWM data and a PWM signal of an image forming apparatus that forms an image of pixels each formed by sixteen auxiliary pixels. The PWM data shown in FIG. 12 corresponds to one pixel of PWM data generated from an input multi-value image data having a density value of 8, and the PWM signal is a drive signal generated from the PWM data, for driving a laser beam source. More specifically, to drive the laser beam source based on the input image data having a density value of 8, as shown in FIG. 12, PWM data of “1” for generating eight high-level states (durations) of a PWM signal, and PWM data of “0” for generating four low-level states (durations) of the PWM signal before and after the eight high-level states are generated, and the generated PWM data is subjected to serial conversion to generate the PWM signal shown in FIG. 12. Then, when the PWM signal is at high level, drive current at a level high enough to cause emission of laser beam is supplied to the laser beam source, whereby the laser beam is emitted from the laser beam source. The number of auxiliary pixels forming one pixel depends on the configuration of the image forming apparatus.

FIG. 13 is a view of PWM data and a PWM signal which are generated in a case where image data having a density value of 8 is continuously input, with no change in magnification (scanning magnification of 100%). As shown in FIG. 13, the PWM data as illustrated in FIG. 12 is continuously generated, and the PWM signal is continuously generated from the PWM data.

FIG. 14 is a view of PWM data and a PWM signal which are generated when the image data having a density value of 8 is continuously input and the scanning length is increased by approximately 6.25%. In the PWM data, a frequency of appearance of an addition position of auxiliary pixel data corresponding to an auxiliary pixel in the PWM data is determined based on the scanning magnification (scanning length) in the main scanning direction. When the scanning magnification is increased by approximately 6.25% (a scanning magnification of 100.625%), auxiliary pixels are added with a frequency of one per sixteen auxiliary pixels. In the example illustrated in FIG. 14, as for a first pixel, the addition position appears immediately after output of a high-level PWM signal section for six auxiliary pixels. As the output of the PWM signal based on the image data proceeds, the addition position changes in phase with respect to the PWM data, and have all possible phase relationships with the PWM data sooner or later. Therefore, where the addition position appears for the first pixel does not affect the following discussion.

As shown in FIG. 14, auxiliary pixel data at an addition position immediately preceding the auxiliary pixel addition position for the first pixel is “1”, and hence auxiliary pixel data to be added for the first pixel is “1”. This causes the entire following PWM data to be shifted rearward by an amount corresponding to one auxiliary pixel. As a consequence, the width of the high-level section of the PWM signal for the first pixel increases.

The auxiliary pixel addition position appears for a second pixel at a location advanced rearward of the auxiliary pixel addition position for the first pixel by an amount corresponding to sixteen auxiliary pixels, and hence PWM data is generated such that auxiliary pixel data is added immediately after output of a high-level PWM signal section for five auxiliary pixels. Auxiliary pixel data at a location immediately preceding the auxiliary pixel addition position for the second pixel is “1”, and hence auxiliary pixel data of “1” is added to the PWM data, and the entire following PWM data is shifted rearward by an amount corresponding to one auxiliary pixel. By similarly executing the processing described above, auxiliary pixel data of “1” is added to PWM data for the following third to sixth pixels. As a consequence, as shown in FIG. 14, it is understood that each time auxiliary pixel data is added, the phase of the auxiliary pixel addition position in the high-level (H) PWM signal section is shifted rearward by an amount corresponding to one auxiliary pixel.

Next, the auxiliary pixel addition position appears for a seventh pixel immediately before the high-level (H) PWM signal section. Since the value of auxiliary pixel data at a location immediately preceding the auxiliary pixel addition position for the seventh pixel is “0”, and hence auxiliary pixel data of “0” is added to data of the seventh pixel, causing the entire following PWM data to be shifted rearward by an amount corresponding to one auxiliary pixel. By similarly executing the processing described above, auxiliary pixel data of “0” is added to PWM data for the following seventh to fourteenth pixels. For a fifteenth pixel, auxiliary pixel data of “1” is added again. For a sixteenth pixel, auxiliary pixel data is added at the same addition position as that for the first pixel.

A time section corresponding to a range of the first pixel to the sixteenth pixel where the positional relationship of the auxiliary pixel addition position with respect to the PWM data returns to an original state is defined as one repetition period, and thereafter the auxiliary pixel data addition operation is periodically repeatedly executed at this repetition period. The number of pixels within one repetition period depends on the frequency of auxiliary pixel addition or the scanning magnification. Now, referring to FIG. 14, “1” is added as auxiliary pixel data for the six pixels of the first half, and insofar as a range illustrated in FIG. 14 is concerned, “0” is added for the seventh to eleventh pixels. Pixels formed based on PWM data having auxiliary image data of “1” added thereto increases the image density, whereas pixels formed based on PWM data having auxiliary image data of “0” added thereto reduces the image density.

As a result of the above-described processing, due to the relationship between image data having a periodicity in the scanning direction and timing (pixel position) in which each auxiliary pixel data is added, interference fringes (moiré fringes) are generated, which generates differences in density gradation, causing degradation of image quality. Although in the above-described example, the processing is performed in a direction of expansion of an image, moiré fringes are generated also when the same processing is performed in a direction of reduction of an image.

### SUMMARY OF THE INVENTION

The present invention provides an image forming apparatus which is capable of properly correcting a scanning length while suppressing occurrence of moiré fringes to reduce degradation of image quality.

In a first aspect of the present invention, there is provided an image forming apparatus that forms, based on image data, an image in which each pixel is formed by a predetermined plurality of auxiliary pixels, and forms a latent image by irradiating laser beam generated from a laser beam source onto a photosensitive member, comprising a drive unit configured to drive the laser beam source based on a lighting pattern including the auxiliary pixels that defines a pattern for turning on or off the laser beam, to thereby generate the laser beam, a first setting unit configured to set a scanning magnification in a main scanning direction of the photosensitive member, a second setting unit configured to set the lighting pattern, based on the image data, according to the scanning magnification set by the first setting unit, pixel by pixel such that the lighting pattern becomes aperiodic in a sequence of pixels, and an output unit configured to output the lighting pattern set by the second setting unit to the drive unit.

In a second aspect of the present invention, there is provided an image forming apparatus comprising a forming unit configured to form a latent image by scanning a photosensitive member by laser beam generated from a laser beam source in a main scanning direction, and forms an image by developing the latent image with toner, and a control unit configured to control the forming unit such that an auxiliary pixel corresponding in size to one of a plurality of portions into which one pixel is divided, is inserted at an aperiodic position in the main scanning direction, so as to increase a width of the image formed on the photosensitive member, in the main scanning direction.

According to the present invention, it is possible to properly correct the scanning length while suppressing occurrence of moiré fringes to reduce degradation of image quality.

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus according to an embodiment.

FIG. 2 is a schematic view of an exposure controller.

FIG. 3 is a view showing a method of generating a laser drive signal (PWM signal) from an input image signal.

FIG. 4 is a PWM lookup table for converting image data input to a CPU to one pixel formed by 100 auxiliary pixels.

FIG. 5 is a flowchart of a process for adding or deleting auxiliary pixels.

FIG. 6 is a continuation of FIG. 5.

FIGS. 7A to 7D are views of PWM data of one pixel appearing in PWM data output as a result of processing on multi-value image data having a density value of 8.

FIG. 8 is a view showing an example of counter values and determination of employment of an auxiliary pixel count in a case where multi-value image data having a density value of 8 is continuously input with a scanning magnification of 99.5%.

FIG. 9 is a view showing an example of counter values and the determination of employment of an auxiliary pixel count in a case where multi-value image data having a density value of 8 is continuously input with a scanning magnification of 99.6%.

FIG. 10 is a view showing an example of counter values and the determination of employment of an auxiliary pixel count in a case where multi-value image data having a density value of 8 is continuously input with a scanning magnification of 100%.

FIG. 11 is a view showing an example of counter values and the determination of employment of an auxiliary pixel count in a case where multi-value image data having a density value of 8 is continuously input with a scanning magnification of 100.2%.

FIG. 12 is a view showing PWM data and a PWM signal of one pixel of image data having a density value of 8, in a conventional image forming apparatus.

FIG. 13 is a view of PWM data and a PWM signal which is output when image data having a density value of 8 is continuously input with no change in a scanning length, in the conventional image forming apparatus.

FIG. 14 is a view of PWM data and a PWM signal which is output when image data having a density value of 8 is continuously input, for expansion of the scanning length by approximately 6.25%.

### DESCRIPTION OF THE EMBODIMENTS

The present invention will now be described in detail below with reference to the accompanying drawings showing embodiments thereof.

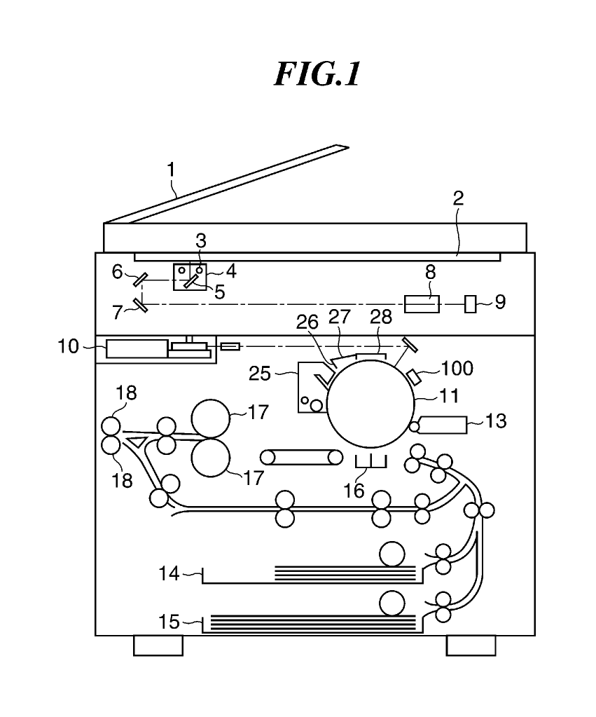

FIG. 1 is a cross-sectional view of an image forming apparatus according to an embodiment of the present invention. The basic operation of the present image forming apparatus will be described with reference to FIG. 1.

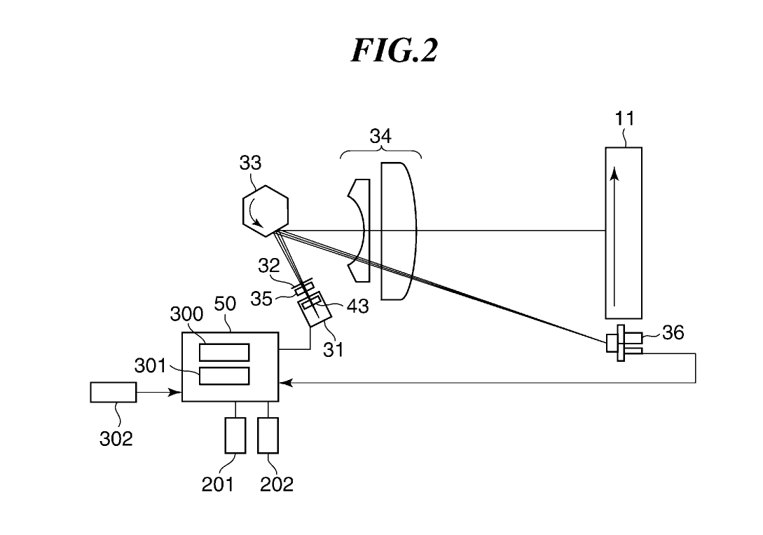

Originals stacked on a document feeder 1 are sequentially fed, one by one, onto an original platen glass 2. When an original is conveyed to the original platen glass 2, a lamp of a scanner 3 is turned on, and at the same time, a scanner unit 4 is moved to illuminate the original. Reflected light from the original passes through a lens 8 via mirrors 5, 6, and 7, and is then input to an image sensor 9. An image signal input to the image sensor 9 is input to an exposure controller 10. The exposure controller 10 controls a laser drive device (drive unit) 31 (see FIG. 2) included in the exposure controller 10 according to image data input from the image sensor 9 to thereby cause emission of laser beam.

A latent image formed on a photosensitive member 11 by laser beam emitted under the control of the exposure controller 10 is monitored by a potential sensor 100 as to whether or not a potential on the photosensitive member 11 has a desired value, and is then developed by a developing device 13.

In the above-mentioned process for forming the latent image on the photosensitive member 11, the exposure controller 10 causes the image signal to be sequentially output onto the surface of the photosensitive member 11 as irradiation light, starting with a first line. The photosensitive member 11 is driven for rotation in synchronism with each output line to repeatedly perform line scanning to thereby form an entire image.

Further, in synchronism with timing for the development of the latent image, a transfer member is conveyed from a transfer member stacking section 14 or 15, and the above-described developed toner image is transferred onto the transfer member by a transfer section 16. The transferred toner image is fixed to the transfer member by a fixing section 17, and is then discharged out of the image forming apparatus by a discharge section 18. After the transfer of the toner image onto the transfer member, the surface of the photosensitive member 11 is cleaned by a cleaner 25 and has charge thereon eliminated by an auxiliary charger 26 such that a primary electrostatic charger 28 can charge the surface of the photosensitive member 11 to an appropriate level again. After that, residual charge remaining on the photosensitive member 11 is removed by a pre-exposure lamp 27, and then the surface of the photosensitive member 11 is charged by the primary electrostatic charger 28. This process is repeatedly carried out, whereby a plurality of images are formed.

FIG. 2 shows the exposure controller 10. The image signal (multi-value image data) output from the image sensor 9 is input to an image processing CPU 50. The image processing CPU 50 generates an image based on the input image data. More specifically, the image processing CPU 50 generates PWM data based on image data using a PWM look-up table, generates a PWM signal as a laser drive signal from the PWM data, and outputs the PWM signal to the laser drive device 31. After performing the conversion using the PWM look-up table, the image processing CPU 50 adds or deletes auxiliary pixel data to and from the PWM data according to the scanning magnification in the main scanning direction. Hereinafter, the image processing CPU 50 is also simply referred to as the “CPU 50”. The CPU 50 functions as a first setting unit, a second setting unit, and an output unit.

The laser drive device 31 receives the laser drive signal from the CPU 50, and supplies drive current to a semiconductor laser 43, which is a laser beam source, on auxiliary pixels. The semiconductor laser 43 has a photodiode (PD) sensor (not shown) provided therein, for detecting part of the laser beam, and the CPU 50 performs automatic power control of a laser diode using a detection signal from the photodiode sensor.

The laser beam emitted from the semiconductor laser 43 is substantially collimated by a collimator lens 35 and an aperture 32, into a parallel laser beam with a predetermined beam diameter, which enters a polygon mirror 33. The polygon mirror 33 rotates at a uniform angular velocity in a direction indicated by an arrow in FIG. 2. The laser beam having entered the polygon mirror 33 is reflected therefrom as a deflected beam continuously changing its angle in accordance with rotation of the polygon mirror 33. The laser beam reflected as the deflected beam is subjected to focusing action by an f-θ lens 34.

On the other hand, the f-θ lens 34 simultaneously corrects a distortion aberration such that the time linearity of scanning is guaranteed, and the laser beam is scanned on the photosensitive member 11 as an image bearing member at a constant speed in a direction indicated by an arrow in FIG. 2. Further, the exposure controller 10 is provided with a beam detection (BD) sensor 36 for detecting reflected light from the polygon mirror 33. A detection signal from the BD sensor 36 is used as a synchronization signal for synchronizing rotation of the polygon mirror 33 with writing of data.

Further, the exposure controller 10 is provided with a PWM lookup table (LUT) RAM 201, and an image RAM 202. The CPU 50 includes an internal counter 300 as well as an internal random number generator 301, which is a generation unit for generating random numbers. Further, an instruction from the user is input to a control panel 302, and information of the input instruction is supplied to the CPU 50.

Next, a description will be given of how the CPU 50 forms one pixel by using auxiliary pixels.

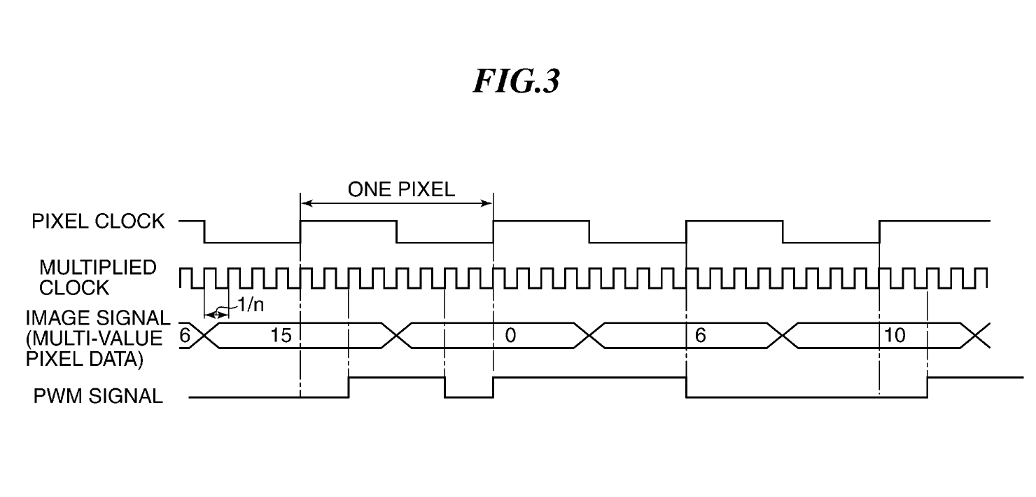

FIG. 3 shows a method of generating a laser drive signal (PWM signal) from an input image signal. The CPU 50 incorporates a quartz oscillator, not shown, for generating a pixel clock illustrated in FIG. 3. Now, it is assumed that one cycle (repetition period) of the pixel clock corresponds to one pixel. The CPU 50 generates a multiplied clock by multiplying the frequency of the pixel clock by n. The multiplied clock is a clock signal for generating a PWM signal from an image signal in order to perform on/off control in units of smaller than one pixel. More specifically, when multi-value image data, referred to hereinafter, is input e.g. with density values 6, 15, 0, 6, . . . , a PWM signal as illustrated in FIG. 3 is generated.

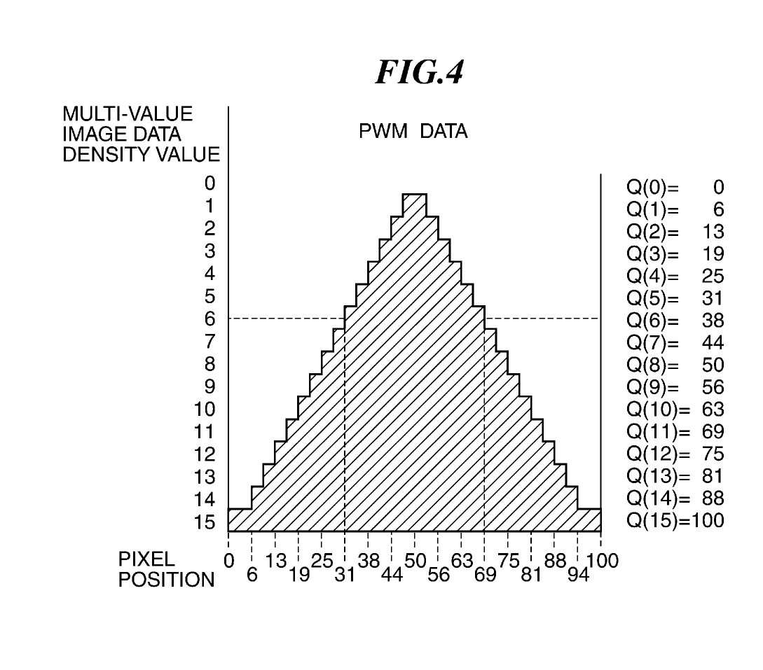

FIG. 4 is the PWM lookup table for converting image data input to the CPU 50 to one pixel formed by 100 auxiliary pixels. This PWM lookup table is stored in advance in the PWM LUT RAM 201.

For example, when a density value of 6 is input to the CPU 50 as multi-value image data, PWM data of “0” is generated in order to form leading first to thirty-first auxiliary pixels of one pixel. Also, in order to form thirty-second to sixty-ninth auxiliary pixels of the pixel, PWM data of “1” is generated. Further, in order to form seventieth to one hundredth auxiliary pixels, PWM data of “0” is generated.

Hereinafter, a process for adding or deleting an auxiliary pixel, executed by the CPU 50, will be described. In the present embodiment, a description will be given of an example of image processing performed in a case where without adjustment of a scanning magnification (scanning length), multi-value image data having a density value of 8 is continuously input to the image forming apparatus in which a predetermined number P of auxiliary pixels forming one pixel is equal to 100.

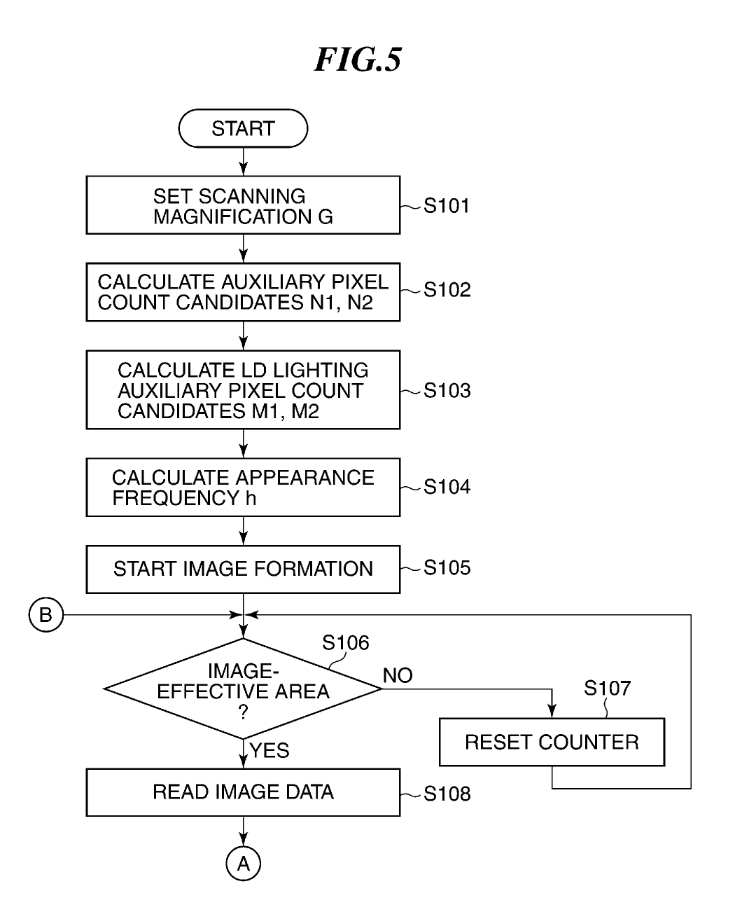

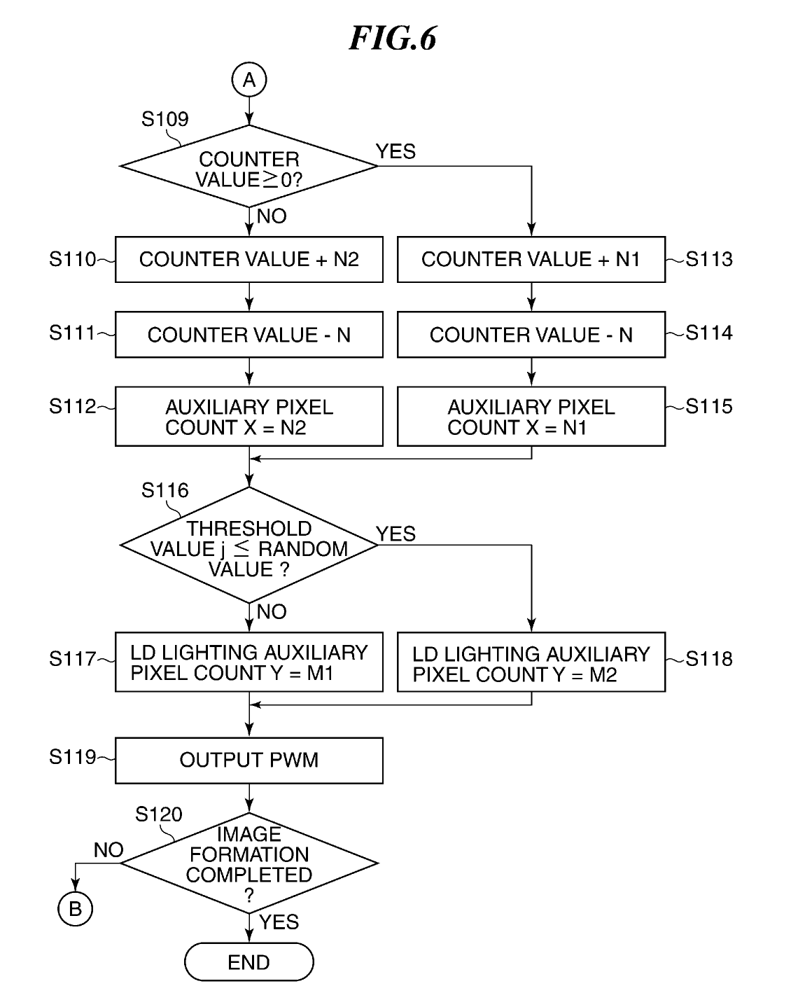

FIGS. 5 and 6 are a flowchart of the process for adding or deleting an auxiliary pixel. A first example shows a process performed in a case where the scanning magnification G in the main scanning direction is 99.5% (reduction by 0.5%).

Hereafter, a lot of variables are used, and hence they are collectively described below.

scanning magnification G (%): a set value indicating the degree of expansion or reduction of the scanning length in the main scanning direction of the photosensitive member 11.

auxiliary pixel count calculated value N: a temporary calculated value for determining the number of auxiliary pixels forming one pixel after a change of the scanning magnification (after adjustment of the scanning length), which takes a value of an integer with a decimal fraction or a value of an integer.

auxiliary pixel count candidates N1 and N2: candidates for the number of auxiliary pixels forming one pixel after a change of the scanning magnification, each of which takes a value of an integer (provided that N2>N1).

auxiliary pixel count X: the number (integer) of auxiliary pixels forming one pixel after a change of the scanning magnification, which is set pixel by pixel, by employing one of the auxiliary pixel count candidates N1 and N2.

LD lighting auxiliary pixel count candidates M1(n) and M2(n): candidates for the number of auxiliary pixels for which the image signal is caused to be at high level, out of the auxiliary pixel count X, each of which takes a value of an integer, wherein n represents a density value of multi-value image data.

LD lighting auxiliary pixel count Y: the number (integer) of auxiliary pixels for which the image signal is caused to be at high level, out of the auxiliary pixel count X, which is set pixel by pixel, by employing one of the LD lighting auxiliary pixel count candidates M1(n) and M2(n).

appearance frequency h: calculated value for determining an employment ratio between N1 and N2 (employment frequencies of N1 and N2).

random threshold value j: calculated value for determining respective employment probabilities for M1(n) and M2(n).

Next, the process for adding or deleting an auxiliary pixel will be described with reference to FIGS. 5 and 6. First, in a step S101, the CPU 50 records and sets the scanning magnification G input from the control panel 302. Then, in a step S102, the CPU 50 determines the auxiliary pixel count candidates N1 and N2 based on the above-mentioned set scanning magnification G. In doing this, first, the CPU 50 calculates the auxiliary pixel count calculated value N by the following equation (1):

N=P×G÷100 (1)

The CPU 50 sets two integers closest to the calculated value N as the auxiliary pixel count candidates N1 and N2 (N2>N1), wherein when N is an integer, N1=N. In the illustrated example, the scanning magnification G is 99.5%, and hence N=100×99.5÷100=99.5 is calculated by the above-mentioned equation (1). Therefore, N1=99 and N2=100 are obtained.

Next, in a step S103, the CPU 50 refers to the PWM lookup table shown in FIG. 4 to determine the LD lighting auxiliary pixel count candidates M1(n) and M2(n). In FIG. 4, Q(n) (n=0 to 15) represents the LD lighting auxiliary pixel count (the number of auxiliary pixels whose PWM data is “1”) with respect to the multi-value image data. Further, a pixel position indicates a position within one pixel where the PWM data turns into “1”. For example, in the case of multi-value image data having a density value of 8 in the present example, the PWM lookup table gives Q(8)=50, which means a high-level length (duration) corresponds to 50 auxiliary pixels. That is, it is understood that PWM data of 25th to 74th auxiliary pixels in one pixel is “1”. The values of M1(n) and M2(n) are calculated by the following equations (2) and (3):

M1(n)=Q(n)−(P−N2) (2)

M2(n)=Q(n)−(P−N1) (3)

wherein n represents an integer from 0 to 15. In the case of the multi-value image data having a density value of 8 in the present example, the above-mentioned equation (2) gives M1(8)=Q(8)−(P−N2)=50−(100−100)=50. Further, the above-mentioned equation (3) gives M2(8)=Q(8)−(P−N1)=50−(100−99)=49. Similarly, as to all of n (integers from 0 to 15), M1(n) and M2(n) are calculated.

Next, in a step S104, the CPU 50 calculates the appearance frequency h based on the values of N1 and N2 and the scanning magnification G. The appearance frequency h is such a value that when a ratio between the employment frequencies of N1 and N2 is (1−h):h, the scanning magnification becomes equal to a value set by the scanning magnification G. The appearance frequency h is calculated by the following equation (4):

N2×h+N1×(1−h)=G (4)

In the case of the scanning magnification G=99.5% as in the present example, this equation gives 100×h+99×(1−h)=99.5, and hence h=0.5. In other words, the ratio between the respective employment frequencies of a pixel formed by 100 auxiliary pixels and a pixel formed by 99 auxiliary pixels is 0.5:0.5 (=1:1), and the number of the auxiliary pixels corresponds to 99.5 from a macroscopic viewpoint, which realizes the scanning magnification of 99.5%.

Next, in a step S105, the CPU 50 receives a print job start instruction signal from the control panel 302, and starts image formation, i.e. starts an image forming process. Further, at this time, the CPU 50 sets a fixed value as an initial value of an output from the internal random number generator 301. For example, assuming that the internal random number generator 301 outputs a 16-bit random value, 0×ffff is set as an initial value thereof. At the start of the image formation, the fixed value is set as the initial value of the output from the internal random number generator 301 so as to make changes in the output value of the internal random number generator 301 constant in every image formation to thereby facilitate grasping of the operating state of the image forming apparatus.

Next, in a step S106, the CPU 50 determines an image-effective area with reference to input timing of a main-scanning synchronizing signal from the beam detection sensor 36. The image-effective area is determined based on the design of construction of the image forming apparatus. An area corresponding to a section of time during which the laser beam reflected from the polygon mirror 33 reaches the surface of the photosensitive member 11 is defined as the image-effective area.

If the present time does not correspond to the image-effective area, in a step S107, the CPU 50 resets the value of the internal counter 300, which is used for selecting the LD lighting auxiliary pixel count Y for one pixel, to 0. Then, the process returns to the step S106. On the other hand, if the present time corresponds to the image-effective area, in a step S108, the CPU 50 reads multi-value image data of one pixel from the image RAM 202, and reads PWM data corresponding thereto from the PWM lookup table in the PWM LUT RAM 201 (see FIG. 4).

Next, in a step S109 in FIG. 6, the CPU 50 determines whether or not the counter value of the internal counter 300 is not smaller than 0. If the counter value is not smaller than 0, the process proceeds to a step S113, whereas if the counter value is smaller than 0, the process proceeds to a step S110.

In the step S110, the CPU 50 adds the value of N2 to the counter value of the internal counter 300, and in the following step S111, the CPU 50 subtracts the value of N from the counter value. Then, in a step S112, the CPU 50 employs the value of N2 as the auxiliary pixel count X, set pixel by pixel, of auxiliary pixels forming one pixel.

On the other hand, in a step S113, the CPU 50 adds the value of N1 to the counter value of the internal counter 300, and in a step S114, the CPU 50 subtracts the value of N from the counter value. Then, in a step S115, the CPU 50 employs the value of N1 as the auxiliary pixel count X.

Next, in a step S116, the CPU 50 proceeds to one of steps S117 and S118 according to a frequency defined by the appearance frequency h. More specifically, the CPU 50 determines whether or not the random threshold value j (a random value output from the internal random number generator 301) holds. If the answer to this question is affirmative (YES), the CPU 50 proceeds to the step S118, whereas if the answer is negative (NO), the CPU 50 proceeds to the step S117.

Here, the internal random number generator 301 outputs a random value pixel by pixel. The internal random number generator 301 uses an M-series random number generation algorithm which is generally widely known. The initial value of the random number is set in the step S105, as mentioned hereinabove. Now, a description will be given of a case where the random value output from the internal random number generator 301 is of 16 bits, by way of example. Since the internal random number generator 301 outputs a 16-bit random value, a value from 0 to 65535 can be output.

In the step S116, first, the CPU 50 calculates the random threshold value j. Note that the random threshold value j may be calculated before the step S116 or in a separately provided step or alternatively in the step S105 along with the setting of the initial value.

The random threshold value j is calculated by the following equation (5):

j=h×(maximum random value+1) (the number is rounded off to an integer) (5)

For example, in the case of 16 bits, since the maximum random value is 65535, j=0.5×(65535+1)=32768 holds. By calculating the random threshold value j, the employment probability is defined on a candidate-by-candidate basis for the LD lighting auxiliary pixel count candidates M1(n) and M2(n) substantially according to the scanning magnification G.

If it is determined in the step S116 that the random threshold value j>(the random value output from the internal random number generator 301) holds, the CPU 50 employs the value of M1 as the LD lighting auxiliary pixel count Y, set pixel by pixel, of auxiliary pixels for which the PWM signal is set to high level, out of the auxiliary pixel count X (step S117). On the other hand, if it is determined in the step S116 that the random threshold value j<(the random value output from the internal random number generator 301) holds, the CPU 50 employs the value of M2 as the LD lighting auxiliary pixel count Y (step S118).

Therefore, the employment probability of M1(n) and that of M2(n) are substantially defined by h and 1−h, respectively. By the way, depending on the value of h, an error can be produced in the employment probabilities of M1(n) and M2(n) due to rounding in the calculation of the random threshold value j. However, it is possible to ignore adverse influence of the error, by employing, as the number of bits of the output from the internal random number generator 301, a number which is large enough to regard the error as negligible.

Next, in a step S119, the CPU 50 outputs PWM data based on the auxiliary pixel count X determined to be employed in the above-described step S112 or S115, and the LD lighting auxiliary pixel count Y determined to be employed in the step S117 or S118. In this PWM data, auxiliary pixels corresponding to the LD lighting auxiliary pixel count Y are generated e.g. such that they are disposed in the center of auxiliary pixels forming one pixel and corresponding to the auxiliary pixel count X. If a fraction is produced when calculation is performed so as to dispose auxiliary pixels corresponding to an LD lighting auxiliary pixel count Y in the center of auxiliary pixels corresponding to an auxiliary pixel count X, auxiliary pixels corresponding to the LD lighting auxiliary pixel count Y are generated by dropping off the fraction. This PWM data is set pixel by pixel according to the scanning magnification G, and becomes aperiodic in a sequence of pixels due to irregularity of employment of the LD lighting auxiliary pixel count Y.

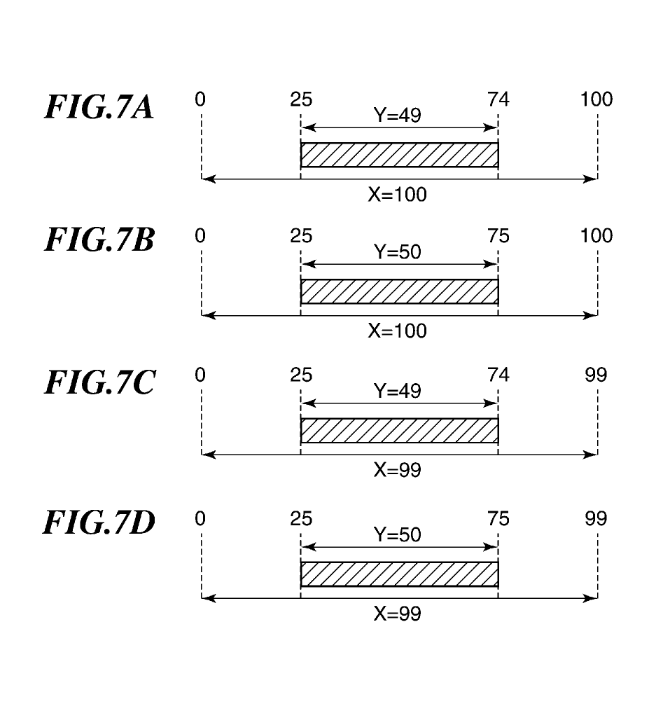

FIGS. 7A to 7D are views showing PWM data of one pixel appearing in PWM data output as a result of processing on the multi-value image data having a density value of 8.

FIG. 7A shows a combination of X=100 and Y=49, FIG. 7B shows a combination of X=100 and Y=50, FIG. 7C shows a combination of X=99 and Y=49, and FIG. 7D shows a combination of X=99 and Y=50.

In the present example, since it is assumed that the appearance frequency h=0.5 holds, a value of 99 or 100 is employed as the auxiliary pixel count X at an employment ratio of 1:1. Further, respective values of 50 and 49 are employed as the LD lighting auxiliary pixel count Y at an employment ratio of 1:1. Therefore, the patterns illustrated in FIGS. 7A to 7D appear with the same frequency.

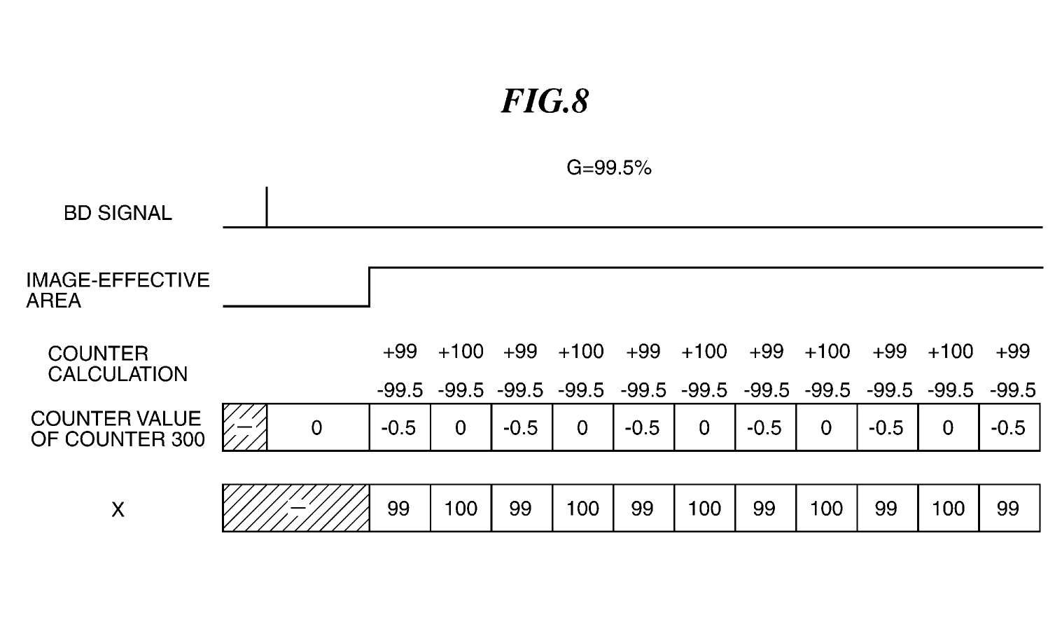

Although a description will be given with reference to FIG. 8 as well, the order of employment of the auxiliary pixel count X is regularly determined, and hence the employment ratio between values thereof is accurate. However, the employment ratio between values of the LD lighting auxiliary pixel count Y is not always accurate since the employment ratio is stochastically made 1:1.

Referring again to FIG. 6, in a step S120, the CPU 50 determines whether or not the image formation has been completed, i.e. whether or not entire output of an image for a page has been completed. If the image formation has not been terminated, the process returns to the above-described step S106, whereas if the image formation has been completed, the present process is terminated.

FIGS. 8 to 11 show examples of counter values of the internal counter 300 obtained by repeatedly carrying out the above-described steps S106 to S120, and determination of employment of the auxiliary pixel count X.

FIGS. 8, 9, 10, and 11 are views showing examples of counter values and the determination of employment of the auxiliary pixel count X in respective cases where multi-value image data having a density value of 8 is continuously input, with scanning magnifications G of 99.5%, 99.6%, 100%, and 100.2%. It is assumed that the internal random number generator 301 outputs a 16-bit random value.

As shown in FIG. 8, the counter value of the internal counter 300 remains 0 until the present time corresponds to the image-effective area after input of the detection signal (BD signal) from the beam detection sensor 36. In FIG. 8, the term “counter calculation” is intended to mean calculation performed in the above-described steps S110, S111, S113 and S114 in FIG. 6. Counter values obtained by the counter calculation are illustrated in boxes of the counter value of the counter 300 in FIG. 8. Further, values of the auxiliary pixel count X each determined to be employed immediately after the counter value is calculated are illustrated in boxes of X.

As shown in FIG. 8, in the case of the above-described first example, if it is determined in the step S109 that the counter value is equal to 0, a process for adding N1 (N1=99) to the counter value (counter value+N1) (step S113) and further a process for subtracting N (N=99.5) from the counter value (counter value−N) (step S114) are performed. As a consequence, a counter value of −0.5 is obtained. As for the pixel being currently processed, the value (99) of N1 is employed as the auxiliary pixel count X (step S115).

As to a next pixel, it is determined in the step S109 that the counter value is equal to “−0.5”, a process for adding N2 (N2=100) to the counter value (counter value+N2) (step S110) and further a process for subtracting N (N=99.5) from the counter value (counter value−N) (step S111) are performed to thereby obtain a counter value of 0. As for the pixel, the value (100) of N2 is employed as the auxiliary pixel count X (step S112). Such processes are repeatedly performed, whereby the counter value alternately takes values of 0 and −0.5. Further, the value (99) of N1 and the value (100) of N2 are alternately determined as the auxiliary pixel count X in a regular order of employment. By the addition and subtraction processes of the counter value, the employment frequency is defined substantially according to the scanning magnification G for each of the auxiliary pixel count candidates N1 and N2.

On the other hand, although the LD lighting auxiliary pixel count Y is not illustrated in FIG. 8, if it is determined in the above-described step S116 that the output random value of the internal random number generator 301 is smaller than the random threshold value j, the value (50) of M1 is employed (step S117). If j the output random value holds, the value (49) of M2 is employed. That is, if the output random value is from 0 to 32767, the value (50) of M1 is employed, whereas if the output random value is from 32768 to 65535, the value (49) of M2 is employed. Insofar as this example is concerned, the respective employment probabilities of the value of M1 and the value of M2 are equal.

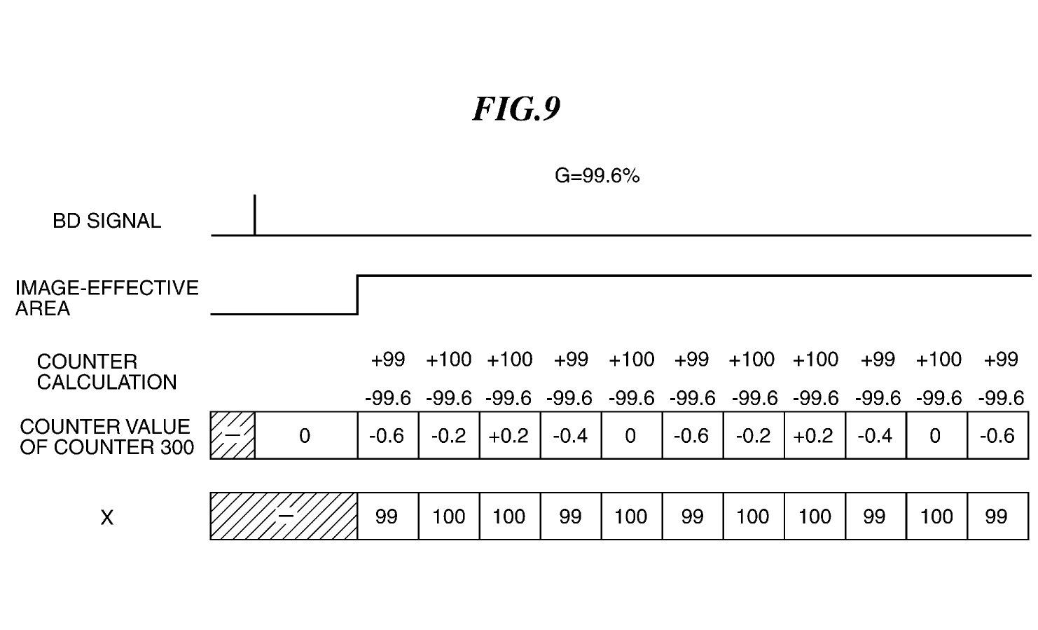

In the case of a second example (scanning magnification G: 99.6%), the results of calculation are as shown in FIG. 9. First, the auxiliary pixel count calculated value N is calculated by the above-mentioned equation (1) to give N=99.6. Since the auxiliary pixel count candidates N1 and N2 are two integers (N2>N1) closest to the value of N, N1 and N2 become equal to 99 and 100, respectively. As for the LD lighting auxiliary pixel count candidates M1(n) and M2(n), assuming that n=8, the aforementioned equations (2) and (3) give M1(n)=50 and M2(n)=49. The appearance frequency h is calculated by the aforementioned equation (4) to give h=0.6. The random threshold value is calculated by the aforementioned equation (5) to give j=39322.

As shown in FIG. 9, in the case of the second example, if it is determined in the above-described step S109 that the counter value of the internal counter 300 is equal to 0, the process for adding N1 (N1=99) to the counter value (counter value+N1) (step S113) and further the process for subtracting N (N=99.6) from the counter value (counter value−N) (step S114) are performed. As a consequence, a counter value of −0.6 is obtained. As for the pixel being currently processed, the value (99) of N1 is employed as the auxiliary pixel count X (step S115).

As to a next pixel, since it is determined in the step S109 that the counter value is equal to −0.6, the process for adding N2 (N2=100) to the counter value (counter value+N2) (step S110) and further the process for subtracting N (N=99.6) from the counter value (counter value−N) (step S111) are performed to give a counter value of −0.2. As for the present pixel, the value (100) of N2 is employed as the auxiliary pixel count X (step S112). Such processes are repeatedly performed, whereby the value (99) of N1 and the value (100) of N2 are regularly employed as the auxiliary pixel count X substantially at an employment ratio of 4:6.

On the other hand, although the LD lighting auxiliary pixel count Y is not illustrated in FIG. 9, if the output random value is from 0 to 39321, the value (50) of M1 is employed, whereas if the output random value is from 39322 to 65535, the value (49) of M2 is employed. Insofar as this example is concerned, the ratio between the respective employment probabilities of the value of M1 and the value of M2 is 6:4.

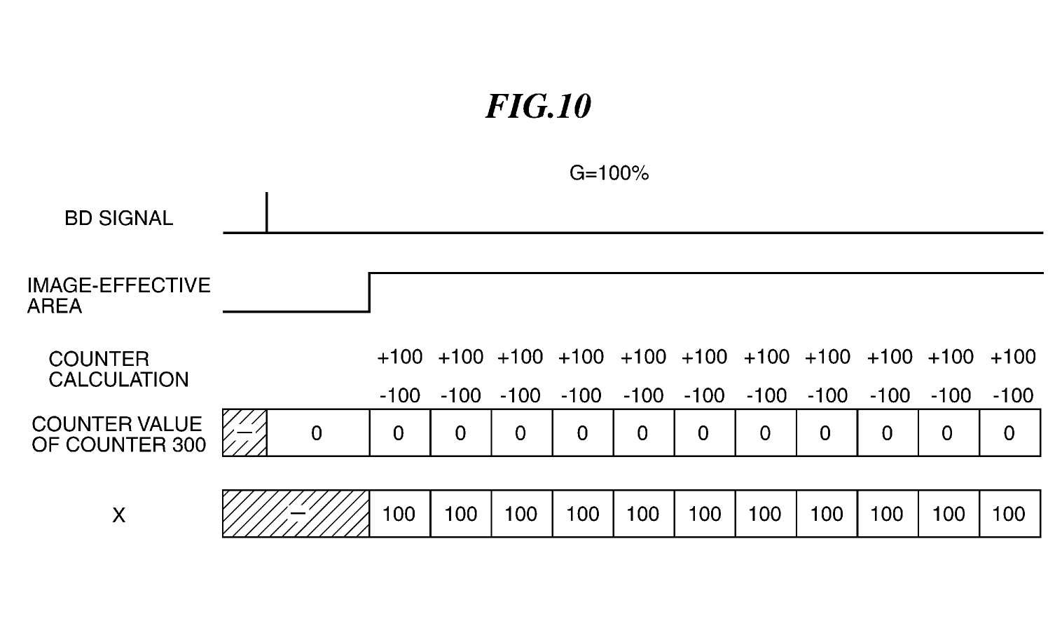

In the case of a third example (scanning magnification G: 100%), the results of calculation are as shown in FIG. 10. Similarly to the first and second examples, the variables are calculated to give N=100, and since this value of N is an integer, N1=100 and N2=101 are obtained. Further, M1=51, M2=50, h=0, and j=0 are obtained. In this example, as shown in FIG. 10, the counter value always becomes equal to 0, and N1=100 is always employed as the auxiliary pixel count X (step S115). As for the LD lighting auxiliary pixel count Y, M2=50 is always employed (step S118).

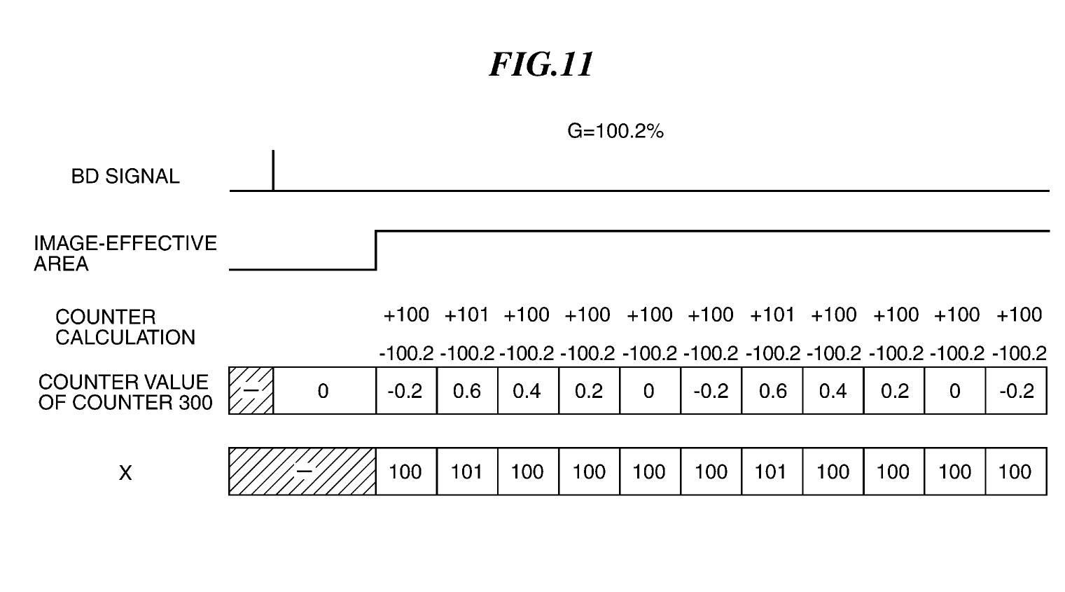

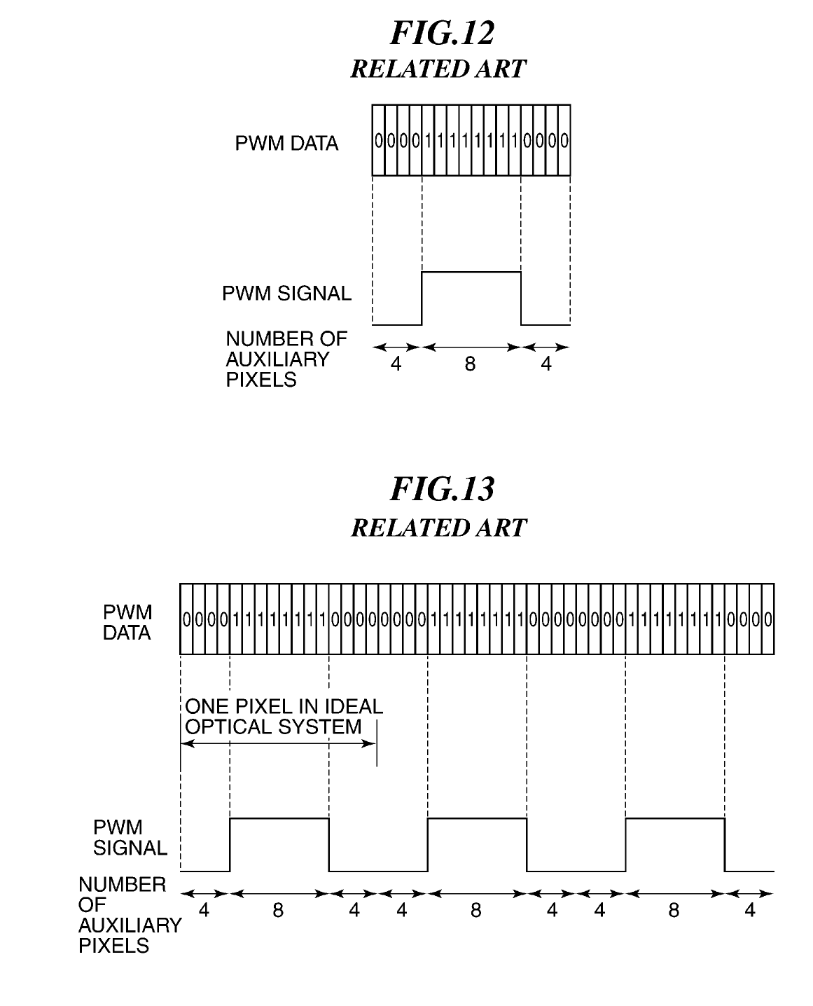

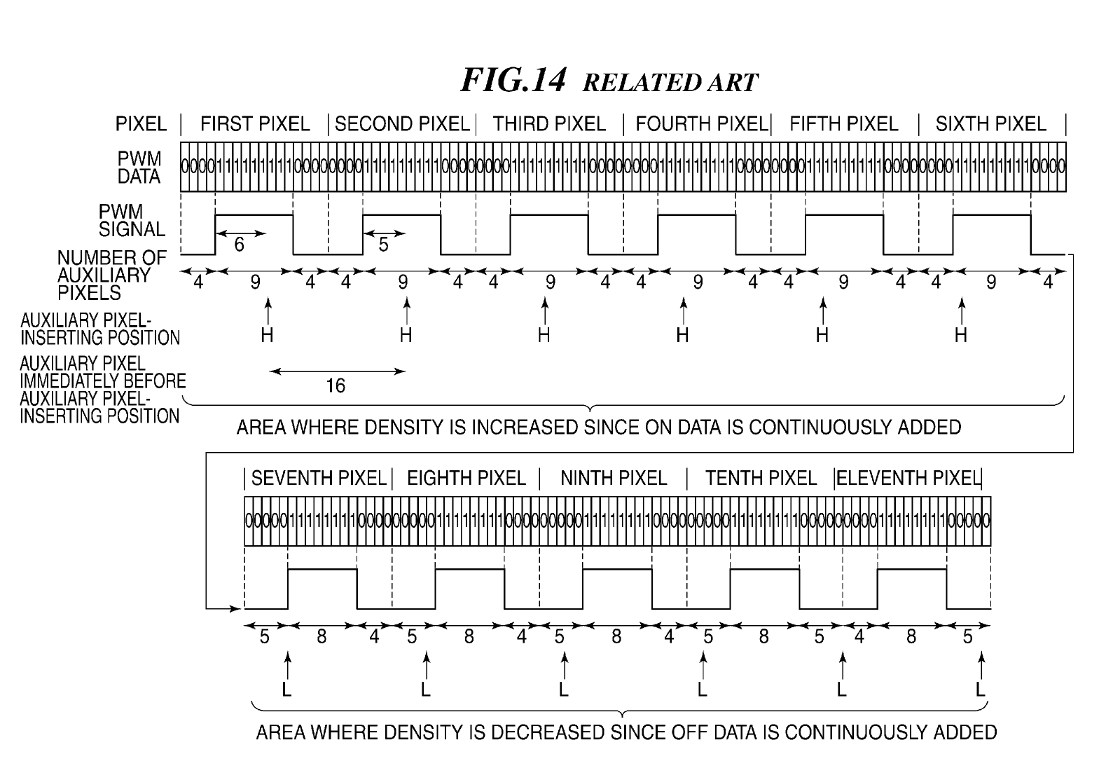

In the case of a fourth example (scanning magnification G: 100.2%), the results of calculation are as shown in FIG. 11. Similarly to the first to third examples, the variables are calculated to give N=100.2, N1=100, and N2=101. Further, M1=51, M2=50, h=0.2, and j=13107 are obtained. In this example, as shown in FIG. 11, the counter value changes such that 0→−0.2→0.6→0.4→0.2→0. As the auxiliary pixel count X, the value (100) of N1 and the value (101) of N2 are regularly employed substantially at an employment ratio of 8:2.

On the other hand, although the LD lighting auxiliary pixel count Y is not illustrated in FIG. 11, if the output random value is from 0 to 13106, the value (51) of M1 is employed, whereas if the output random value is from 13107 to 65535, the value (50) of M2 is employed. Insofar as this example is concerned, the ratio between the employment probabilities of the value of M1 and the value of M2 is 2:8.

According to the present embodiment, the LD lighting auxiliary pixel count Y is selected and employed pixel by pixel such that the LD lighting auxiliary pixel count Y becomes aperiodic in a sequence of pixels, so that it is possible to suppress occurrence of moiré fringes to suppress differences between density gradations caused by the moiré fringes, thereby reducing degradation of image quality. This makes it possible to properly correct the scanning length while reducing degradation of image quality.

Moreover, one of the LD lighting auxiliary pixel count candidates M1 and M2 is employed as the LD lighting auxiliary pixel count Y, according to the employment probabilities set for the respective candidates M1 and M2 according to the scanning magnification G. This causes the LD lighting auxiliary pixel count Y to conform to a density value of 8 of the multi-value image data as a whole, though the addition position of auxiliary pixel data of “1” is irregular. Particularly, the employment of the LD lighting auxiliary pixel count candidate M1 or M2 is determined based on the result of comparison between the random value output from the internal random number generator 301 and the threshold value j. Therefore, the bias of the probability is small, and the construction therefor is simple.

Although in the above-described embodiment, the order of employment of the values of N1 and N2 as the auxiliary pixel count X is determined by the counter value and is fixed, it is only required to employ each of them at a frequency of employment determined for one repetition period, but the order of employment of them does not matter. Therefore, the method used in the present invention is not limited to the above-described determination method using the counter values.

Further, although in the above-described embodiment, the auxiliary pixel count X is regularly determined, when the PWM data is to be set pixel by pixel such that the PWM data becomes aperiodic in a sequence of pixels, similarly to the LD lighting auxiliary pixel count Y, there may be set employment probabilities for the values of N1 and N2 as the auxiliary pixel count X. In this case, a determination step similar to the step S116 in FIG. 6 may be set as the step S109 so as to cause one of the values of N1 and N2 to be selected and employed by comparison between the output random value of the internal random number generator 301 and the random threshold value j.

After all, insofar as the effect of suppressing moiré fringes is concerned, it is only required to cause at least one of the auxiliary pixel count X and the LD lighting auxiliary pixel count Y to be determined for employment, with an irregularity. For example, in FIG. 6, the steps S112 and S117 may be interchanged and at the same time the steps S115 and S118 may be interchanged. In addition, to realize the irregularity, it is not necessarily required to use random numbers.

Further, although in the above-described embodiment, the number of the auxiliary pixel count candidates N1 and N2 and the number of the LD lighting auxiliary pixel count candidates M1(n) and M2(n) are each set to two (for the same density value), it is only required to set a plurality for each, that is, three or more candidates may be set for each.

Next, a description will be given of a case where four candidates are set for each of the auxiliary pixel count X and the LD lighting auxiliary pixel count Y, by way of example. Let it be assumed that four candidates N1 to N4, which are integers close to the value (100) of N, are provided as the auxiliary pixel count candidates under conditions that P=100 and G=99.5%. The values of N1, N2, N3, and N4 are 98, 99, 100, and 101, respectively. Further, as for the LD lighting auxiliary pixel count candidates as well, four candidates M1 to M4 are provided. Through application of the aforementioned equations (2) and (3), there are used fours equations of M1(n) to M4(n)=Q(n)−(P−N4 to N1). Assuming that n=8, the values of M1, M2, M3, and M4 are calculated as 51, 50, 49, and 48, respectively. Further, through application of the aforementioned equation (4), an equation of N3×h+N2×(1−h)=G is used to calculate the appearance frequency h. Furthermore, through application of the aforementioned equation (5), an equation of j2=h×(maximum random value+1) is used to calculate a random threshold value j2.

Then, random threshold values j1 and j3 are calculated by respective equations of j1=j2/2 and j3=3×j2/2. The LD lighting auxiliary pixel count Y is determined depending on to which range the output random value of the internal random number generator 301 belongs, when compared with the random threshold values j1, j2, and j3. That is, as the values of a range to which the output random value belongs are larger, one of M1, M2, M3, and M4 is employed as the LD lighting auxiliary pixel count Y in this order.

Note that when converting image data input to the CPU 50 to each pixel formed by a plurality of auxiliary pixels, the PWM lookup table is used by way of example, and another method may be employed, which uses e.g. equations.

As described heretofore, to suppress occurrence of moiré fringes to thereby properly correct the scanning length while reducing degradation of image quality, in the case of increasing the width of an image formed on the photosensitive member 11 in the main scanning direction, auxiliary pixels are caused to be inserted at aperiodic positions in the main scanning direction.

In the conventional example of the related art, positions of insertion of respective auxiliary pixels (addition positions) are periodic. On the other hand, in the example of control according to the present invention, positions of insertion of respective auxiliary pixels are set to aperiodic positions. In this case, to increase the width of an image in the main scanning direction, the CPU 50 corrects the PWM signal so as to insert the auxiliary pixels at the aperiodic positions in the main scanning direction. In doing this, the CPU 50 corrects the PWM signal such that each inserted auxiliary pixel is formed under the same exposure conditions (the same value and at the same high or low level) as an auxiliary pixel located immediately before or after a position where the auxiliary pixel is inserted. As illustrated in FIG. 3 by way of example, a width (lateral length in FIG. 3) over which the PWM signal is caused to be at high level is determined according to the density value of multi-value pixel data located immediately before the current pixel data to which the PWM signal corresponds with respect to. Note that the exposure conditions of the inserted auxiliary pixel may be the same as the auxiliary pixel located immediately after the inserted auxiliary pixel.

Further, to make aperiodic an insertion position where an auxiliary pixel is inserted, the CPU 50 determines the insertion position using a random value. In this case, it is preferable that the CPU 50 controls the exposure controller 10 and the developing device 13 such that the position where an auxiliary pixel is inserted occurs with a frequency dependent on the scanning magnification G input from the control panel 302 in the main scanning direction. As the random value, there may be used one generated e.g. by the above-mentioned internal random number generator 301. Alternatively, a device for storing predetermined random value data may be provided to use the random value data stored therein.

In the example of the control according to the present invention, the CPU 50 forms a control unit, a conversion unit, a correction unit, and a setting unit, and the exposure controller 10 and the developing device 13 form a forming unit.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2011-162048 filed Jul. 25, 2011, which is hereby incorporated by reference herein in its entirety.

What is claimed is:

1. An image forming apparatus that forms, based on image data, an image in which each pixel is formed by a predetermined plurality of auxiliary pixels, and forms a latent image by irradiating laser beam generated from a laser beam source onto a photosensitive member, comprising:
a drive unit configured to drive the laser beam source based on a lighting pattern including the auxiliary pixels that defines a pattern for turning on or off the laser beam, to thereby generate the laser beam;
a first setting unit configured to set a scanning magnification in a main scanning direction of the photosensitive member;
a second setting unit configured to set the lighting pattern, based on the image data, according to the scanning magnification set by said first setting unit, pixel by pixel such that the lighting pattern becomes aperiodic in a sequence of pixels; and
an output unit configured to output the lighting pattern set by said second setting unit to said drive unit.

2. The image forming apparatus according to claim 1, wherein in setting the lighting pattern pixel by pixel, said second setting unit sets, according to the predetermined number of auxiliary pixels and the scanning magnification set by said first setting unit, a count of auxiliary pixels forming each pixel and a count of to-be-lit ones of the auxiliary pixels forming each pixel, both of the counts being integers, pixel by pixel, and sets at least one of the counts such that the at least one of the counts becomes aperiodic in a sequence of pixels.

3. The image forming apparatus according to claim 2, wherein said second setting unit sets a plurality of candidates for the count of the to-be-lit auxiliary pixels in each pixel, and employs one of the plurality of candidates as the count of the to-be-lit auxiliary pixels, according to an employment probability set for each candidate according to the scanning magnification.

4. The image forming apparatus according to claim 3, further comprising a generation unit configured to generate a random number, and
wherein said second setting unit sets a threshold value associated with the employment probability set for each candidate, and employs one of the plurality of candidates as the count of the to-be-lit auxiliary pixels, according to a result of comparison between a value generated by said generation unit and the threshold value.

5. The image forming apparatus according to claim 3, wherein said second setting unit sets a plurality of candidates for the count of the auxiliary pixels forming each pixel in the lighting pattern, and employs one of the plurality of candidates such that frequency of selection of the one of the plurality of candidates becomes equal to an employment frequency set for each of the plurality of candidates according to the set scanning magnification, in a sequence of pixels.

6. An image forming apparatus comprising:
a forming unit configured to form a latent image by scanning a photosensitive member by laser beam generated from a laser beam source in a main scanning direction, and forms an image by developing the latent image with toner; and
a control unit configured to control said forming unit such that an auxiliary pixel corresponding in size to one of a plurality of portions into which one pixel is divided, is inserted at an aperiodic position in the main scanning direction, so as to increase a width of the image formed on the photosensitive member, in the main scanning direction.

7. The image forming apparatus according to claim 6, wherein said control unit includes a conversion unit configured to convert an image signal to a drive signal for causing laser beam to be emitted from the laser beam source, and a correction unit configured to correct the drive signal so as to insert the auxiliary pixel at the aperiodic position in the main scanning direction, and
wherein said correction unit corrects the drive signal such that the auxiliary pixel for insertion is formed under the same exposure conditions as exposure conditions of an auxiliary pixel located immediately before or after a position where the auxiliary pixel for insertion is inserted.

8. The image forming apparatus according to claim 6, wherein said control unit determines the position where the auxiliary pixel is inserted, by using a random number.

9. The image forming apparatus according to claim 6, further comprising a setting unit configured to set a scanning magnification of the photosensitive member in the main scanning direction, and
wherein said control unit controls said forming unit such that the position where the auxiliary pixel is inserted occurs in the main scanning direction, with a frequency dependent on the set scanning magnification.
